(19) United States
(12) Patent Application Publication
(10) Pub. No.: US 2017/0255887 A1
(43) Pub. Date: Sep. 7, 2017

(54) WORKFLOW SERVER WITH ENHANCED DOCUMENT RELEASE

(71) Applicants: Kristine Louise DeLay, Weston, CT (US); Scott D. Mastie, Longmont, CO (US)

(72) Inventors: Kristine Louise DeLay, Weston, CT (US); Scott D. Mastie, Longmont, CO (US)

(73) Assignee: Ricoh Company, Ltd., Tokyo (JP)

(21) Appl. No.: 15/060,208

(22) Filed: Mar. 3, 2016

(51) Int. Cl. G06Q 10/06; H04L 29/06

(52) U.S. Cl. CPC G06Q 10/0633; H04L 63/10

(57) ABSTRACT

Systems and methods are provided for a workflow server that includes an interface configured to receive data that indicates a type of a release event over a communication medium, wherein completion of the release event results in the at least one document being sent over a predetermined channel at a predetermined time for an intended audience. The workflow server also includes a release module configured to process a step of the workflow selected for the release event to identify an authorized user, to cause a display device to display information of the release event, to determine whether the release event is valid based on a response from the authorized user, and to send the one or more documents over the predetermined channel at the predetermined time when the release module determines that the release event is valid.

### FIELD OF THE INVENTION

The invention relates to the field of document management for a job, and in particular, to workflow systems for releasing a document of a job to the public.

### BACKGROUND

Publically traded companies and other entities regularly release information to the public in the form of financial statements, press releases, and other disclosures. When such information is released at the incorrect time or channel, or with inaccuracies, the company may be subject to fines from a governing body (e.g., Securities and Exchange Commission (SEC)), trading volatility, and bad press. Preparation for releasing information to the public often necessitates manual coordination among several different departments or individuals to approve or provide input prior to the release event. Releases may be further complicated by differences in market time zones and overlapping policies/rules for which information is to be sent to which public channels in which specific order/time. As a result, companies are prone to the occasional mistake in releasing information to the public given the frequency of release events and the potential for human error in navigating the rules and managing documents for different types of release events. Therefore, there continues to be a need for processes that guide the release of information to the public in a way that is timely, secure, and error free.

### SUMMARY

Embodiments described herein use a workflow approach for releasing information to the public at a planned time. The workflow lays out the process for the preparation and sign-off of documents before the documents may be released to the desired markets or entities at a predetermined time. User-configurable steps in the workflow allow for customized authorization and release of documents. The steps may also ensure the documents to be released remain secure and on schedule for the release event.

One system is an apparatus that includes a workflow server. The workflow server includes an interface configured to receive data that indicates a type of a release event over a communication medium, wherein completion of the release event results in one or more documents being sent over a predetermined channel at a predetermined time for an intended audience. The workflow server also includes a release module configured to process a step of the workflow selected for the release event to identify an authorized user, to cause a display device to display information of the release event, to determine whether the release event is valid based on a response from the authorized user, and to send the one or more documents over the predetermined channel at the predetermined time when the release module determines that the release event is valid.

Other exemplary embodiments (e.g., methods and computer-readable media relating to the foregoing embodiments) may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of a workflow system in an exemplary embodiment.

FIG. 2 is a block diagram illustrating a graphical user interface for generating and editing a workflow in an exemplary embodiment.

FIG. 3 is a flowchart illustrating a method for processing a release event through a workflow in an exemplary embodiment.

FIG. 4 illustrates a GUI of a release event workflow in an exemplary embodiment.

FIG. 5 illustrates active release events for client workflows in an exemplary embodiment.

FIG. 6 illustrates a GUI for editing steps of a print workflow in an exemplary embodiment.

FIG. 7 illustrates a processing system operable to execute a computer readable medium embodying programmed instructions to perform desired functions in an exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

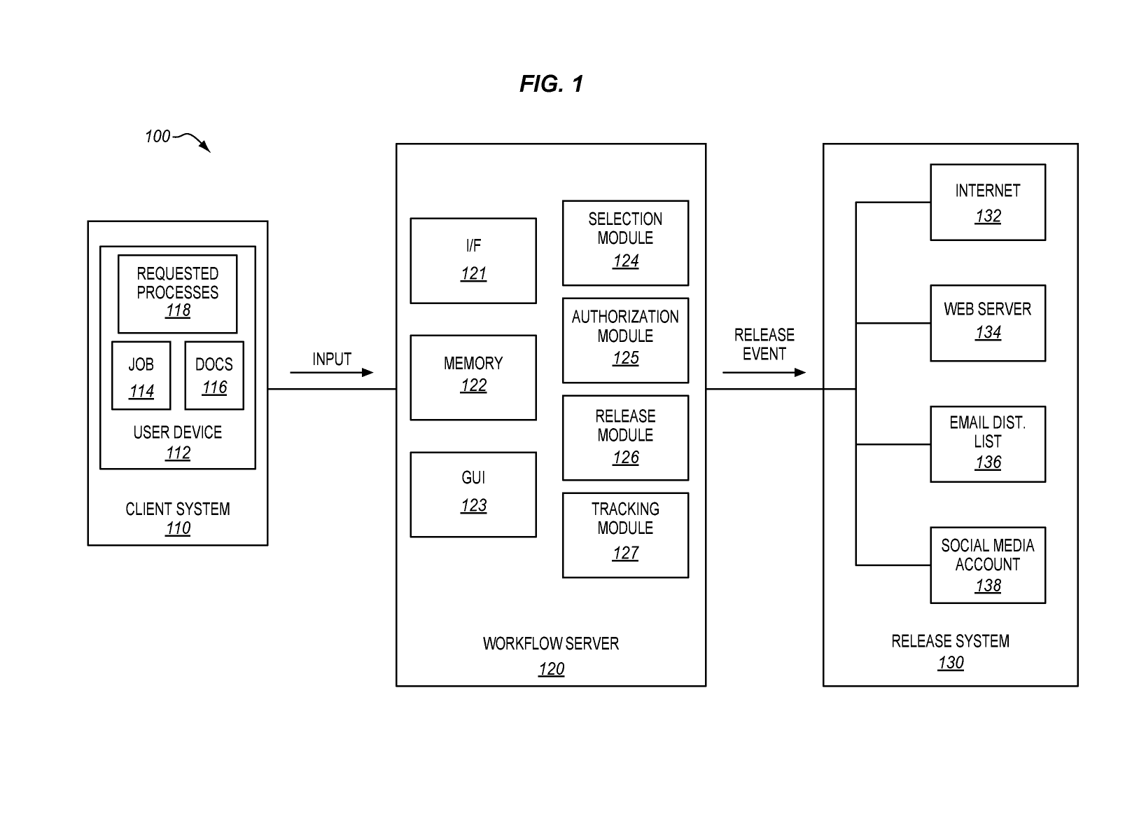

FIG. 1 is a block diagram of a workflow system 100 in an exemplary embodiment. Workflow system 100 may include a client system 110, a workflow server 120, and a release system 130. Client system 110 may generate/store files, such as jobs 114 and/or documents 116, and the workflow server 120 receives or retrieves the files as a release event and schedules the files to be released to an intended recipient via release system 130. Client system 110 may also be configured with a requested processes module 118 that enables user(s) of the workflow server 120 to initiate pre-defined processing of release events. As used herein, a release event relates to action(s) performed at a specific point in time that cause one or more documents to be available to the general public. A user may refer to an individual or group of individuals which are authorized to direct processing for a release event.

The workflow server 120 is enhanced with a selection module 124, an authorization module 125, a release module 126, and a tracking module 127 that collectively manage a release event with a series of steps within a workflow. Previously, companies handled release events by relying on third party firms or individuals within its communications department to manually send/email material financial news of the company on a particular day, at a particular time (taking into account relative time zones, and daylight savings time), and over a particular channel (e.g., SEC filing, press release, company website posting, etc.). As will be described in greater detail below, modules 124-127 implement a workflow approach to handling release events that may reduce errors, increase document security, and provide detailed tracking/recording of actions taken leading up to the release event for improved auditing and scheduling of release events.

Workflow server 120 includes an interface 121 that supports communication with devices and systems over a network (e.g., Ethernet, wireless, etc.) such as user device(s) 112 of client system(s) 110, or release object(s) 132-138 of release system 130. Interface 121 may also support communication among various components (e.g., elements 121-127) of workflow server 120 in the form of a local system bus or other type of local connections. Workflow server 120 may further includes memory 122 (e.g., Random Access Memory (RAM), a hard disk, etc.) for storing workflows, release events, client settings, etc., and may also include a Graphical User Interface (GUI) 123 that allows for manipulation of workflows and other settings on workflow server 120. Workflow server 120 may comprise physical computer servers, virtual or cloud systems (e.g., VMWare or other virtualized platforms), or some combination thereof.

In general, selection module 124, authorization module 125, release module 126, and tracking module 127 may process a release event according to configurable steps defined in the workflow chosen for the release event. Selection module 124 is any system, component, or device operable to select a workflow from a plurality of workflows for processing a release event. Authorization module 125 is any system, component, or device operable to request/receive authorization or other types of input before documents are allowed to be released for the release event. Release module 126 is any system, component, or device operable to send documents over one or more channels according to the appropriate authorization, time, and other parameters defined for a release event. Tracking module 127 is any system, component, or device operable to monitor/record events or progress of a release event and its document(s) that are to be released as the release event travels through a selected workflow. Tracking module 127 may be further operable to provide scheduling, timing, and security functions for the release event. Modules 124-127 may be implemented as custom circuitry, a processor executing programmed instructions, etc. Not all modules may be needed for every workflow server. For example, if only a single workflow is used by the workflow server then the selection module 124 may be omitted.

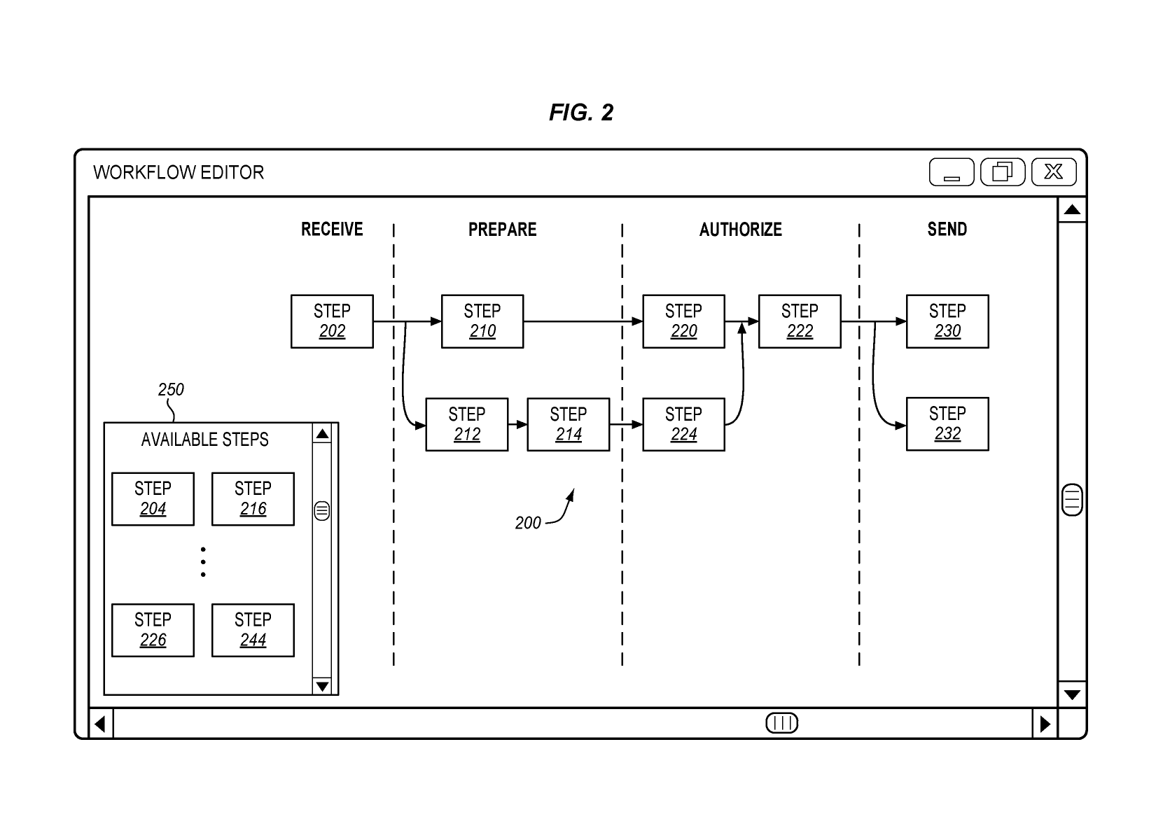

FIG. 2 is a block diagram illustrating a graphical user interface (e.g., GUI 123 of print server 120) for generating and editing a workflow 200 in an exemplary embodiment. A user (e.g., an administrator of workflow server 120) may drag-and-drop available steps 250 into phases (e.g., Receive, Prepare, Authorize, Send) and make logical connections between the steps to form a workflow 200. Other programming techniques known to those skilled in the art may also be used. A properly configured workflow 200 may be subsequently assigned by workflow server 120 to a job that defines a release event for one or more documents. As the release event travels through the workflow 200, each step processes the release event based on rules/parameters configured for that step and forwards the release event to the next step in the sequence until the appropriate document(s) are released for public view at a predetermined time or deleted from the workflow. Predetermined items may be specified by an authorized user as a particular time/date or alternately may be an algorithm/function that creates the item based on other inputs (e.g, the date that the algorithm/function is run).

A step of the workflow may define conditions to be satisfied in order for the release event to advance to a subsequent step defined in the workflow. Additionally, one or more step(s) in the workflow may collectively define conditions to be satisfied before document(s) are released for public view. In the exemplary workflow 200 of FIG. 2, a release event may travel through one of multiple potential paths before the documents of the release event are ultimately released for public availability in the Send phase. For instance, a release event may be processed according to a first path that includes steps 202, 210, 220, 222, and 230, or alternatively may be processed according a second path that includes steps 202, 212, 214, 224, 222, and 232. Alternatively or additionally, a release event may be assigned to one of multiple workflows which define differently configured paths/steps from one another.

As will be described in greater detail below, decisions regarding the particular workflow or path that processes the release event may be based on properties of the release event and/or triggering events encountered as the release event proceeds through the workflow path. For example, a company press release may travel through a different workflow or path than a company financial report. As such, in the Prepare phase, the different paths may direct workflow server 120 to request different documents or document inputs to be provided by different users (e.g., get statement text from User A for press release and get numerical input of quarterly financial results from User B for financial report). In the Authorize phase, the different paths may direct workflow server 120 to request authorization for releasing documents of the job from different individuals or groups within the company (e.g., get authorization from Communications Department for press release and get authorization from Chief Financial Officer (CFO) for financial report, etc.). And, in the Send phase, the different paths may send documents over different channels (e.g., generate a post to a company website for a press release and send to a New York Stock Exchange (NYSE) email distribution list for a financial report).

Rules and/or objects defined within a step direct modules 124-127 to request, cause, or direct action from a particular system, device, object, or person. For example, authorization module 125 may communicate (e.g., via interface 121) with a particular user device 112 of client system 110 to obtain authorization to proceed with the release event, and release module 126 may send (e.g., via interface 121) document(s) at specific times for the release event via one or more release objects 132-138 of release system 130. In the exemplary embodiment of the workflow system 100 in FIG. 1, release objects 132-138 of release system 130 include internet 132, web server 134, email distribution list 136, and social media account 138, though it will be appreciated that other devices may be included in workflow system 100 (e.g., one or more printers, post-print devices, etc.) including additional or alternative devices for directly or indirectly releasing documents to the public, such as releases to third parties. It will further be appreciated that alternative phases, steps, rules and numbers or combinations thereof other than those explicitly discussed herein are possible.

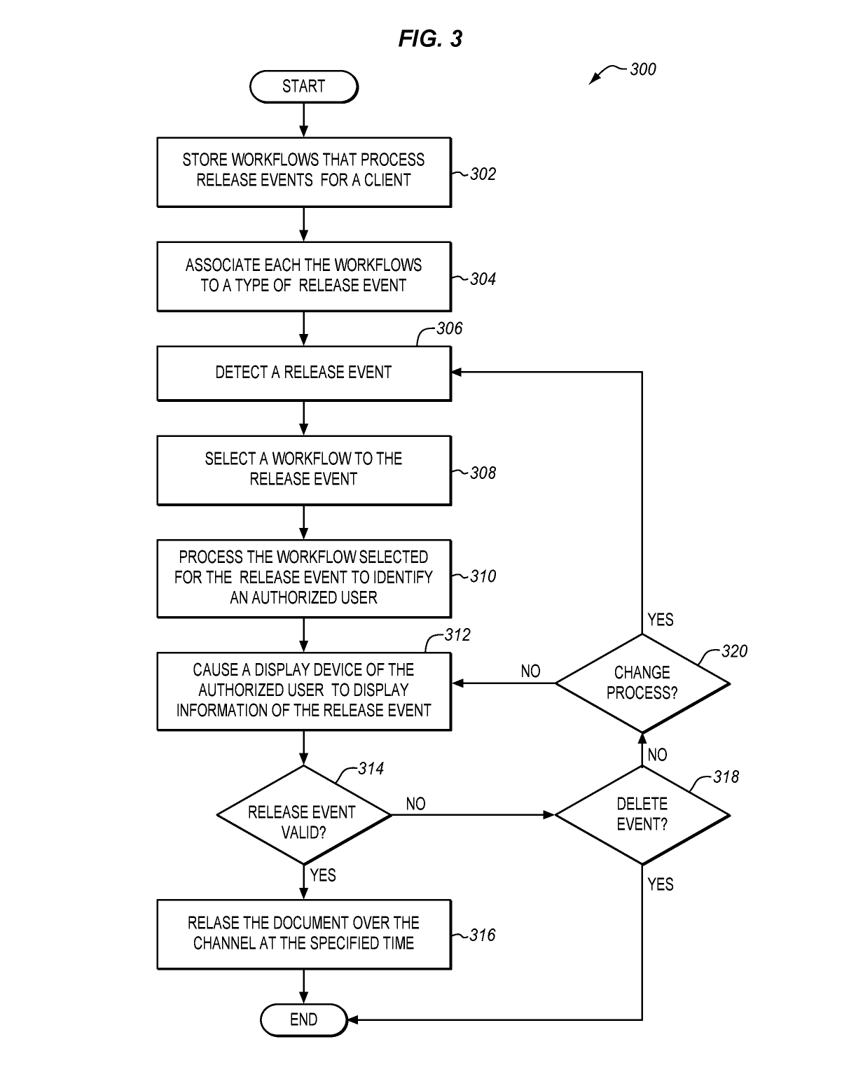

Illustrative details of the operation of workflow system 100 will be discussed with regard to FIG. 3. The steps of methods are described with reference to workflow system 100 of FIG. 1, but those skilled in the art will appreciate that the steps may be performed in other systems, are not all inclusive, may include other steps not shown, and may be performed in alternative orders.

FIG. 3 is a flowchart illustrating a method 300 for processing a release event with a workflow in an exemplary embodiment. In step 302, memory 122 stores workflows that process release events for a client. An administrator of workflow server 120 or user of client system 110 may login to workflow server 120 to generate a workflow via GUI 123 and store it in memory 122. Each stored workflow may be correlated with a particular account or client in memory 122.

In step 304, selection module 124 associates each workflow with a type of a release event. Selection module 124 may identify an association between a workflow and a type of release event based on file/folder name of the workflow, file/folder location, an association stored in memory 122 or a database, etc. An administrator of workflow server 120 or user of client system 110 may login to workflow server 120 to assign a workflow to a category or a type of release event.

Types of release events may include, for example, triggered releases, amended releases, template releases, and periodic releases. A triggered release event discloses information in response to an electronic feed. The electronic feed may identify actions and/or individuals which relate to a client's business such as insider trading of shares (e.g., a publically traded company may be compelled to make public purchases or sales of shares of top executives within the company). In one embodiment, workflow system 100 may implement hot folders or interfaces which allow a user of client system 110 or workflow server 120 to submit files for a release event so that the associated workflow begins processing automatically in response to the submission of file(s) (or particular file(s)) to the hot folder or interface. Alternatively or additionally, selection module 124 may be configured to detect database queries and initialize a workflow in response to a particular query or information contained within the query. Numerous different protocols and formats for database queries are possible including Structured Query Language (SQL), Simple Object Access Protocol (SOAP), Extensible Markup Language (XML), etc. In yet another embodiment, workflow server 120 initiates processing for a release event via the requested processes module 118 that enables users to select and initiate pre-defined processes.

An amended release discloses a modification to information which has already been previously disclosed to the public. The SEC, for example, has formal procedures for filing amended quarterly or annual reports. GUI 123 of workflow server 120 may display a menu option or button which may be selected by an administrator or user of client system 110 to trigger processing for a workflow for the amended release. Selection module 124 may access the previous release event or job and one or more steps within the workflow appends document(s) (e.g., a Portable Document Format (PDF) document) which include the amended content and sends both the document(s) previously released along with the document(s) that include the amendments (e.g., in accordance with SEC policy). To do this, selection module 124 may fetch a previously processed release event (or job) and back it up in the workflow to a desired point/step (e.g., to a step that requests document attachment). As the release event is re-processed in the workflow, both the original and amended information may be retained and associated with the job. Alternatively, the workflow may create a child job from the original release event to process the amended release information, and which references the original release but is managed as a separate event.

A template release discloses information in response to selection of a template. GUI 123 of workflow server 120 may display a menu option or button which allows an administrator or user of client system 110 to select a category or template previously stored in memory 122. A template may comprise blanks which may be populated by an appropriately authorized user before or during the processing of the release event within the workflow. This quickly initializes the content and processing of the release event to enable fast response to news events (e.g., company press release statement, etc.). As one example, a client may setup templates as pre-built press releases (e.g., for merger and acquisition news of the company) with only a few minor variables unfilled (e.g., date of release, effective date, price per share, etc.) and which may remain unfulfilled up until a predetermined amount of time (e.g., a few hours before release).

A periodic release event discloses information on a reoccurring basis (e.g., quarterly, annually, etc.). Various governing bodies and standards for reporting financial information such as the SEC, NYSE, NASDAQ, Electronic Data-Gathering, Analysis, and Retrieval (EDGAR), etc. stipulate the reporting of particular documents/information at specific times and intervals. Some entities may also issue periodic press release statements concurrently with financial reporting or announce information regarding tradeshows or other repeating business events. As such, selection module 124 may create shell jobs that automatically initialize processing in a workflow at predetermined intervals or times. The shell job may initially comprise an empty container object which collects content as it initializes and processes through the workflow. Steps of the workflow may trigger alerts (e.g., emails) to attach documents, files, content which may be subsequently reviewed/released in accordance with steps of the workflow that processes the shell job.

In step 306, selection module 124 detects a release event. Selection module 124 may detect a release event based on data received for a release event over a communication medium at interface 121, a hot folder, a database feed, a document or shell job automatically spawned in memory 122, etc. Selection module 124 may identify the type of release event from the data for the release event itself or determine the type of release event based on additional or alternative information such as file/folder location of the received data, an association stored in memory 122 or a database, etc.

In one embodiment, the document(s) to be released is included within the job/data which defines the release event. In another embodiment, the job defining the release event is a shell job which contains information regarding certain parameters for the release event but not the document(s) themselves. As such, the document(s) identified in data for the print job may be actually added/appended to the job/workflow after the job has already been detected/received and is in the course of processing for release in a workflow. Additionally, the timing for releasing document(s) may be predetermined in the data for the job/release event or may be predetermined during the course of processing the release event in the workflow. Data received or correlated with the release event may identify the document(s) to be released, a type of document, a time for the release event, a channel for the release event, a workflow for the release event, a company/user associated with the release event, etc.

In step 308, selection module 124 selects a workflow for the release event. Selection module 124 may select or assign a workflow for a job that defines a release event based on document(s) sent with the job, a type or format of the document/job, a type of release event, the date of the release event, a user or account associated with the job/document, a user selection, etc., or some combination thereof. In one embodiment, workflow system 100 may implement hot folders or interfaces which allow a user of client system 110 or workflow server 120 to submit files for a release event. Selection module 124 may identify the hot folder or interface (or client/user associated therewith) which received the file(s) and choose a workflow for the job based at least in part on this information. Additionally, selection module 124 may select a workflow to process the release event from among a plurality of workflows. That is, selection module 124 may select from a pool of candidate workflows. Selection module 124 may determine the pool of candidate workflows based on data received or correlated with the release event, the user/client associated with the release event, etc. Alternately, the authorized user may select the appropriate workflow from the choices of workflows stored in workflow server 120. With the workflow selected, modules 124-127 may process the release event as a job according to the configured steps within the selected workflow.

In step 310, authorization module 125 processes the workflow selected for the release event to identify an authorized user. Authorization module 125 may analyze the workflow or phase in the workflow in which authorization occurs to a detect step(s) in the workflow which has been configured with instructions for obtaining authorization for the release event. An authorization step(s) in the workflow may identify authorized users in the configured rules/parameters of the step itself or point to an object in memory or a database that correlates the workflow with authorized users.

The workflow selected for processing the release event may comprise different steps from other candidate workflows for authorizing the release event before the one or more documents are sent at the predetermined time. Two workflows may differ, for example, by the specific individual or group authorized to review, sign-off, or provide input to the content of the release event as it processes in the workflow. Alternatively or additionally, two workflows may differ by the number/order of authorization steps in the workflow, by the types of triggering events which cause re-authorization step(s) to be performed (e.g., modification to document(s) of the release event, modification to the release time/channel, cancellation of the release event, etc.), or by the configuration of re-authorization step(s) themselves. Thus, the workflow selected for processing may comprise a different process/step(s) to perform before completion of the release event which results in one or more documents being sent over a predetermined channel at a predetermined time for public availability. In one embodiment, each of the workflows in a pool of candidate workflows which may be selected comprise a different authorization process. In another embodiment, a modification to the release event or documents of the release event during processing in the workflow triggers a re-authorization process that includes sign-off by at least two users before the release event may proceed in the workflow.

In step 312, authorization module 125 causes a display device of the authorized user to display information of the release event. Authorization module 125 may identify contact information for the display device in the configured rules/parameters of the authorization step itself or from a pointer or object in memory or a database that correlates a contact for the display device with an authorized user or user identification (ID). Display devices may include any device or combination of device(s) (e.g., personal computer, mobile device, GUI 123, user device 112, etc.) capable of displaying information sent over a network (e.g., Internet, intranet, cell network, etc.) to particular recipient(s) (e.g., via user accounts, user IDs, phone numbers, etc.).

Authorization module 125 may receive or retrieve the information that is to be displayed to the authorized user from a step(s) of the workflow, a client setting stored in memory, data recorded by tracking module 127, or some combination thereof. Tracking module 127 is configured to record values/attributes for the release event in a customizable manner as it travels in a workflow. The workflow or client settings may indicate which triggering events/actions and/or attributes to record in memory as the release event processes through the workflow. Exemplary triggering events include cancellation or modification of the release event, arrival of one more files into the hot folder, reception of user authorization for a step in the workflow, etc. Exemplary attributes include an indication of job progress (e.g., status of release event with the workflow), an identification of a time/user associated with a previous interaction with the workflow or release event, a deadline for completing a step with in the workflow, etc. Tracking module 127 may identify the properties to track based on user input defining those properties, or may access parameters stored in memory 122 to determine which document properties to track. For instance, rules of which types of properties to track may be defined by the workflow processing the release event. Tracking module 127 may monitor the identified properties continuously, periodically, or in response to triggering events as desired.

In step 314, authorization module 125 determines whether the release event is valid based on a response from the authorized user. Authorization module 125 may deem the release event valid if all conditions defined in the authorization step(s) of the selected workflow are fulfilled. The authorization step(s) may indicate a particular type of response (e.g., GUI selection, email), a particular format of the response (e.g., response to include particular text in email header, a password, a numerical input, a minimum word count, etc.), a particular user to provide the response (e.g., user ID, email address), a particular interface to receive the response (e.g., predetermined hot folder that is actively monitored), or some combination thereof. Thus, authorization module 125 may deem the release event valid based on an expected response from the authorized user as defined by the authorization step(s) and/or client settings.

If the release event is valid, the process proceeds to step 316 and release module 126 sends the one or more documents over the predetermined channel at the predetermined time. The send steps and/or client settings of the workflow may be configured such that the action for making the documents of the release event available to the general public (e.g., emailing contacts, etc.) may occur automatically (e.g., in the absence of manual input) at the predetermined time given that the release event remains valid up to the point of release.

Otherwise, if the release event has not been validated, or becomes invalid as a result of a modification to the release event, authorization module 125 may proceed to steps 318 and/or 320. In step 318, authorization module 125 determines whether to delete the release event from the workflow and end processing for that release event. If the release event is not to be deleted, authorization module 125 proceeds to step 320 and determines whether to change processing for the release event. If the release event is not to change processes, authorization module 125 may send further prompts for authorization and repeat steps 312-314. Authorization module 125 may send further prompts to additional or alternative user(s) than those previously messaged and/or may send additional or alternative content than that of previous message(s). Tracking module 127 may be configured to trigger further prompts in response to a determination that the release event is behind schedule (e.g., the predetermined time for the release event is within a certain amount of time).

Otherwise, if the release event is to change processes, the process proceeds to step 306 to restart the release event or select a new workflow for the release event according the repeated step(s) of workflow 300. Accordingly, changes to the release event may force a backup and re-do as appropriate and may occur/iterate any number of times until the release event is approved for release. That is, a release event may be considered a draft in the prepare phase of the workflow up until it is validated by an appropriate number of users and becomes final or is deleted or moved into a different process. Determination of deletion of the release event at step 318 and determination of whether to a change the processing for the release event at step 320 may require their own sign-off process and/or conditions. For example, deletion of a quarterly report may be allowed on the condition that a new quarterly report is restarted in a workflow, whereas a press release may be deleted by the appropriate users without such a condition.

The method 300 provides an advantage over previous techniques for handling release events in that the process for authorizing a release event comprises a defined and ordered set of activities that organize the process of releasing important information by strict yet customizable parameters. Additionally, the workflow approach described guides the release of information to the public in a way that is timely, secure, and error free while providing an auditable trail of the handling of documents leading up to the release event.

In one embodiment, tracking module 127 is configured to manage various scheduling and timing tasks related to a release event. Tracking module 127 may detect/determine time differences among users or objects associated with a release event. For example, the workflow server 120 controlling the release of information may be located in a different time zone than the client/company to which the release event pertains, the various users involved in the review process for the release event, and/or the intended audience/recipient which receives the release event for distribution to the public. Accordingly, tracking module 127 may identify time differences of various entities associated with the release event based on a step or settings of the workflow.

Furthermore, tracking module 127 may record log entries or generate messages which indicate the relative time difference of an event or action for the release event. As an example, tracking module 127 may identify a local time corresponding to the predetermined time for releasing documents of the release event for the workflow server, and identify a recipient time corresponding to the predetermined time for a recipient associated with the predetermined channel for the release event. In recognition that the local time and the recipient time are different (e.g., located in different time zones), tracking module 127 may inform authorization module 125 of the time difference so that the information displayed to the user includes both the local time and the recipient time which correspond to the different time zones at the time the document release is to occur. For example, in a multi-time zone example, tracking module 127 may indicate, for all logs and messages, “Release for March 2nd 4:05 PM EST=March 2nd 2:05 PM Local time” to include both time zones and the content variables for the release event. In one embodiment, tracking module 127 records a complete history of all steps and all user actions and retains such information for lookup availability according to a predetermined amount of time after the occurrence of the release event.

Alternatively or additionally, tracking module 127 may detect a deletion event of one or more documents of the print job while the document is in the workflow. Tracking module 127 may detect user input requesting that document(s) or a print job be removed from the workflow. Thus, the deletion event may occur at the workflow server 120 (e.g., as a result of operator input at GUI 123), and may be directly related to the processing or removal from processing of the document in the workflow. Tracking module 127 may record an entry for each of the one or more documents in a history file. Each entry in the history files indicates values of properties for the documents. Thus, after a deletion event of a document or print job has been detected, information describing that document or release event is stored in one or more history files in memory. As used herein, an entry is a textual or numeric field that describes a different aspect of the release event. An entry may describe any suitable properties of a document (and accompanying contextual information) that may be determined while the document is within the workflow. Examples of an entry in the history file may include, but is not limited to, a time the deletion event occurred, a current activity in the workflow at the time of the deletion event, a status of the document/activity at the time of the deletion event, who viewed the document, information describing the deletion event, etc.

A history file may include a series of entries for an individual document or multiple documents. Tracking module 127 may generate new history files or identify existing files to add new entries in a manner customizable by user input or according to the conditions for recording deleted documents as defined in workflow server 120 and/or the workflow. For instance, history files may be dedicated to a predetermined type of document, a date or range of dates in which the deletion event occurred, properties of the release event or workflow, etc. A user may generate a search request (e.g., via a remote client or directly via a user interface at server 110) and provide it to tracking module 127 for retrieval of information of the deletion event at a later time.

In yet another embodiment, tracking module 127 provides encryption of data which pertains to a release event. For example, tracking module 127 may encrypt documents at rest (e.g., stored at workflow server 120) and unencrypt the relevant documents in response to processing an authorization step that involves an appropriately authorized user to view the documents. Tracking module 127 may implement or interact with a secure browser function that enables viewing of unencrypted documents by authorized persons. For instance, tracking module 127 may unencrypt data when it is viewed within a Single Sign-On (SSO) authenticated session and encrypt such data otherwise.

In another embodiment, in addition to the enhanced document release features described herein, workflow server 120 is configured to process and schedule print jobs. Accordingly, workflow server 120 may handle an incoming print job (e.g., a print file and accompanying job ticket) from client system(s) 110 and process print jobs with print workflows that define a digitally ordered series of activities to perform upon the documents of the print job (e.g., preparing, scheduling, printing, post-print handling, inserting, mailing, etc.). As such, workflow server 120 may receive data for a release event in formats that conform with print job processing (e.g., Portable Document Format (PDF), Advanced Function Presentation (AFP)) and may further receive/process accompanying information for the release event in the form of a job ticket (e.g., Job Definition Format (JDF) job ticket instructions, etc.). It will be appreciated that although certain functions have been described with respect to various modules (e.g., selection module 124, authorization module 125, release module 126, tracking module 127, etc.), that any of modules 124-127 or combination of modules may be configured to perform the functions described herein.

### EXAMPLES

In the following examples, additional processes, systems, and methods are described in the context of a workflow system that releases documents to the general public. In this example, a workflow server is accessible over the Internet via secure browser sessions. A client submits jobs/files in the browser session facilitated by a GUI (e.g., GUI 123) of the workflow system.

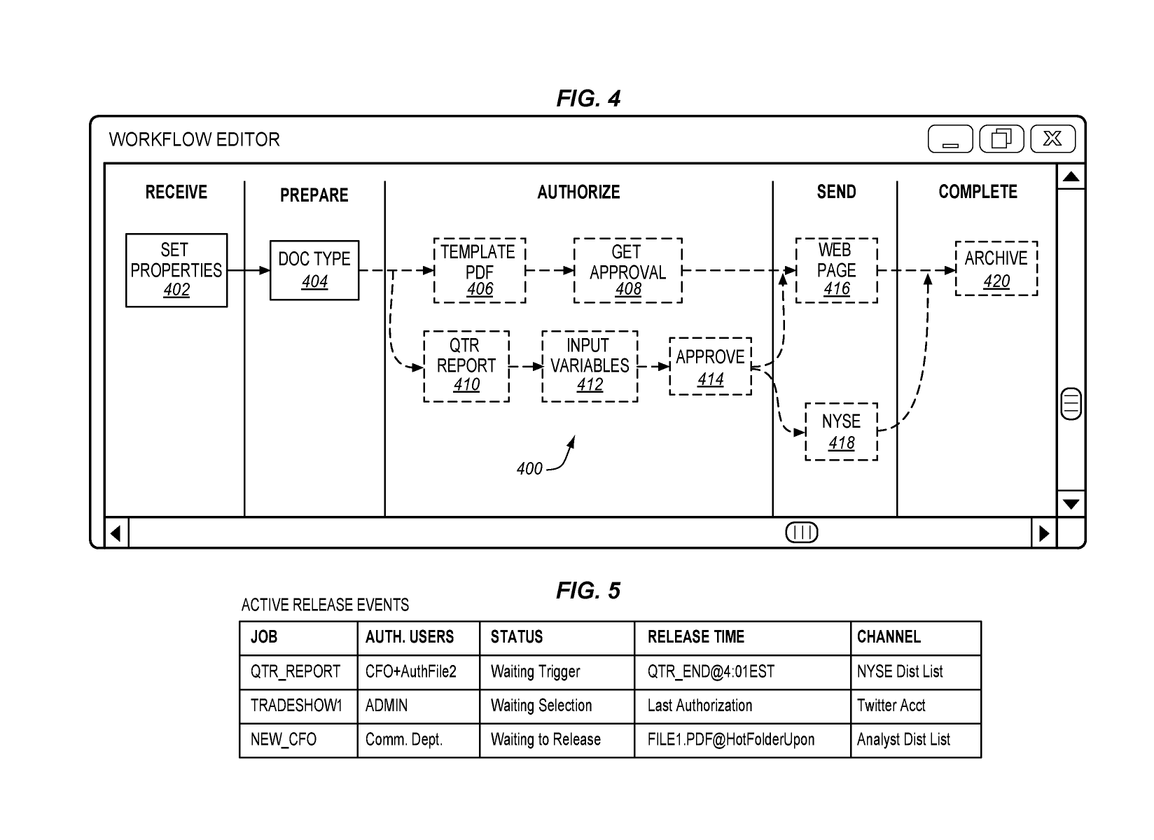

FIG. 4 illustrates a GUI of a release event workflow 400 in an exemplary embodiment. Assume, for the sake of this example, that the workflow server has received multiple release events for a client and has stored the release events and loaded associated client properties according to step 402 in the Receive phase. Accordingly, the workflow server identifies active release events either waiting to initialize in a workflow, currently processing in a workflow, or which have completed all conditional steps for release and are waiting to be released according to a specific time.

As documents are received at workflow interface, they are processed according to step 404 in the Prepare phase and swept into a selected workflow accordingly. FIG. 5 illustrates active release events for client workflows in an exemplary embodiment. In this example, the workflow server identifies three active release event jobs to process for the client. The first release event is a quarterly financial report job that identifies a user (e.g., CFO) and file (e.g., Authfile2) to be referred to for authorization. It also identifies a release time as QTR END at 4:01 Easter Standard Time (EST). Since quarterly financial reports reoccur periodically, the job name and/or time for release may be expresses in variables (e.g., “<Qtrname><YR>Financials” could resolve to “2Q15 Financials” or “2nd Quarter 2015 Financials” according to client preferences for the values of <Qtrname> and <YR>). The quarterly financial report release event also indicates the channel for distribution is a NYSE distribution list file which may referred to in the Send phase.

The second release event is a tradeshow announcement that is to be authorized by a user administrator of the workflow server (e.g., ADMIN), and that releases upon completion of the last authorization step of the chosen workflow path. The announcement release indicates access information for a social media account to announce the contents of the file (e.g., Twitter Account). The third release event is a company announcement of a new Chief Financial Officer (CFO) that indicates review by the Communications Department prior to release and which is sent to an analyst distribution list file (e.g., containing email contacts) when a specific file is placed into a hot folder (e.g.,. FILE1.pdf). The workflow server determines that the third release event is in a “waiting to release” state. Thus, the workflow server monitors a system date/time for countdown to the release event and/or monitors the hot folder for retrieval of the predetermined files and performs the release event accordingly since its status indicates all authorization requirements have been met.

By contrast, the quarterly financial report and the tradeshow announcement are in “waiting trigger” and “waiting selection” states, respectively, indicating that further steps are to be performed for authorization as a condition prior to release. Accordingly, the workflow server assigns the first release event and the second release event to different workflow configurations. The quarterly financial report is selected to process in a workflow defined by steps 410, 412, 414, 416, 418, and 420, and the tradeshow announcement is selected to process in a workflow defined by steps 406, 408, 416, and 420.

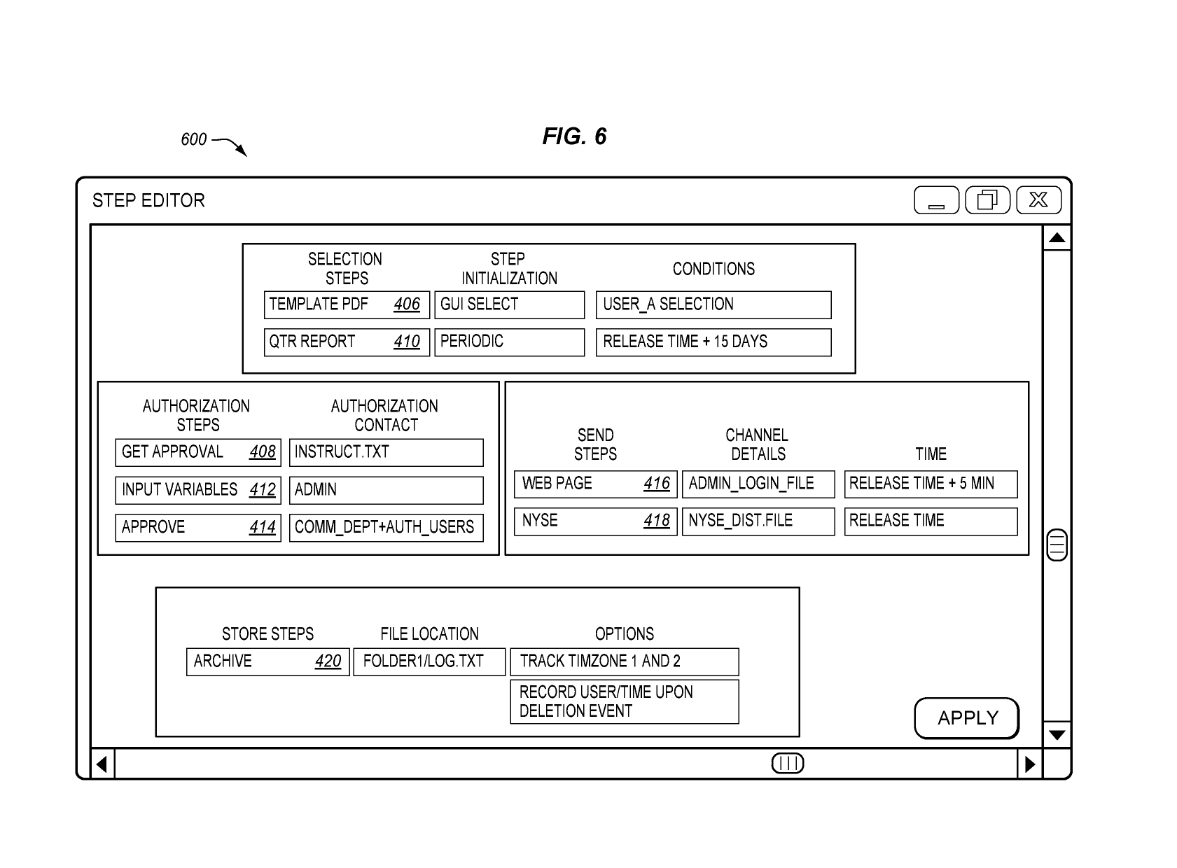

FIG. 6 illustrates a GUI for editing steps of a print workflow in an exemplary embodiment. Here, the GUI presents each of the steps 406-420 in the print workflow and allows users to edit conditions, rules, and assigned durations to each step. In this example, the steps are categorized into selection steps, authorization steps, send steps, and store steps. Settings for each step may be selected or configured by an authorized user by typing into the corresponding box and/or selecting from a list of options in a drop down box. Here, the settings of Template PDF step 406 indicate that the step is initialized when it is selected by User_A in the GUI. Accordingly, the tradeshow announcement release event is selected to begin processing at step 406. By contrast, the settings of Quarter Report step 410 indicate that this step is initialized periodically 15 days ahead of the release time of the report. As such, a shell job automatically spawns and is selected to begin processing at step 410 at a specific time defined by client/job settings (e.g., depending on the defined time for quarter end of the client). Thus, for this example, quarterly reports for the client are automatically initialized in the workflow and the conditions for releasing the quarterly report may be met within the 15 day window leading up to the predetermined time of the release.

The documents for each release event are handled by different workflow activities as they progress. The tradeshow announcement is authorized according the configured settings of step 408 while the quarterly financial report is authorized according to the configured settings of step 412 and 414. Accordingly, the workflow server accesses an instruct.txt file for the tradeshow announcement and analyzes the content therein for contacting users. And, the workflow server prompts an administrator to provide input variables at step 412 for the quarterly financial report. When that is complete, the quarterly financial report proceeds to step 414 and contacts members of the company's communications departments according to file contents of Comm_Dept and also contacts the CFO and other users according to contents of another file AuthFile2 since the step refers to properties of the release event. Thus, users review both the planned date/time of the event and the local equivalent, as well as the information that is to be released.

The quarterly financial report is the released according the settings of step 416 and 418. First, the report is sent to contacts within a NYSE distribution file at the predetermined time for the release. Then, five minutes later, the report is published to a web page automatically using the login credentials for posting to the company site located in an administrator login file. The tradeshow announcement is released only according to step 416. At step 420, details of each release event is recorded in an appropriate log.

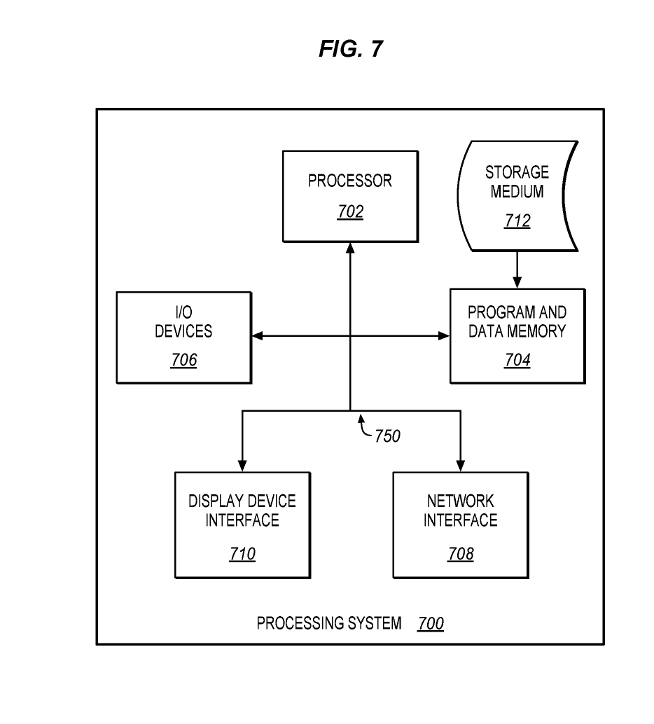

Embodiments disclosed herein can take the form of software, hardware, firmware, or various combinations thereof. In one particular embodiment, software is used to direct a processing system of workflow server 120 to perform the various operations disclosed herein. FIG. 7 illustrates a processing system 700 operable to execute a computer readable medium embodying programmed instructions to perform desired functions in an exemplary embodiment. Processing system 700 is operable to perform the above operations by executing programmed instructions tangibly embodied on computer readable storage medium 712. In this regard, embodiments of the invention can take the form of a computer program accessible via computer-readable medium 712 providing program code for use by a computer or any other instruction execution system. For the purposes of this description, computer readable storage medium 712 can be anything that can contain or store the program for use by the computer.

Computer readable storage medium 712 can be an electronic, magnetic, optical, electromagnetic, infrared, or semiconductor device. Examples of computer readable storage medium 712 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 700, being suitable for storing and/or executing the program code, includes at least one processor 702 coupled to program and data memory 704 through a system bus 750. Program and data memory 704 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 706 (including but not limited to keyboards, displays, pointing devices, etc.) can be coupled either directly or through intervening I/O controllers. Network adapter interfaces 708 may also be integrated with the system to enable processing system 700 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 710 may be integrated with the system to interface to one or more display devices, such as printing systems and screens for presentation of data generated by processor 702.

Although specific embodiments were described herein, the scope of the invention is not limited to those specific embodiments. The scope of the invention is defined by the following claims and any equivalents thereof.

We claim:

1. An apparatus comprising:
a workflow server comprising:
an interface configured to receive data that indicates a type of a release event over a communication medium, wherein completion of the release event results in at least one document being sent over a predetermined channel at a predetermined time for an intended audience; and
a release module configured to process a step of the workflow selected for the release event to identify an authorized user, to cause a display device to display information of the release event, to determine whether the release event is valid based on a response from the authorized user, and to send the one or more documents over the predetermined channel at the predetermined time when the release module determines that the release event is valid.

2. The apparatus of claim 1 wherein:
the release module is configured to identify a local time corresponding to the predetermined time for the workflow server, and to identify a recipient time corresponding to the predetermined time for a recipient associated with the predetermined channel, wherein the local time and the recipient time are different; and
the release module is configured to cause the display device to display the information of the release event including a display of the predetermined time for both the local time and the recipient time.

3. The apparatus of claim 1 wherein the release module is configured to monitor a file location for reception of a predetermined file, and to determine that the release event is valid if the predetermined file is received from the authorized user at the file location before the predetermined time.

4. The apparatus of claim 1 wherein the release module is configured to determine that the release event is valid when a condition of the step indicates a response format that is met by the response of the authorized user, and to release the at least one document over the predetermined channel at the predetermined time for public availability.

5. The apparatus of claim 1 wherein the workflow server further comprises:
a selection module configured to select a workflow to process the release event from among a plurality of workflows based on the type of release event, wherein the plurality of workflows each comprise a different step from one another for authorizing the release event before the one or more documents are sent at the predetermined time, and wherein the different step in the workflow points to an object in memory that identifies contact information of the authorized user.

6. The apparatus of claim 1 wherein the release module is configured to prevent sending the one or more documents over the predetermined channel at the predetermined time when it is determined that the release event is invalid.

7. The apparatus of claim 6 wherein the release module is configured to cause the display device of an authorized user to re-display information of the release event in response to a determination that the release event is invalid and that the predetermined time is within a threshold amount of time.

8. A method comprising:
receiving data for a release event over a communication medium, wherein completion of the release event results in at least one document being sent over a predetermined channel at a predetermined time for an intended audience;
processing a step of the workflow selected for the release event to identify an authorized user;
causing a display device to display information of the release event;
determining whether the release event is valid based on a response from the authorized user; and
sending the at least one document over the predetermined channel at the predetermined time when it is determined that the release event is valid.

9. The method of claim 8 further comprising:
identifying a local time corresponding to the predetermined time for the workflow server;
identifying a recipient time corresponding to the predetermined time for a recipient associated with the predetermined channel, wherein the local time and the recipient time are different; and
causing the display device to display the information of the release event including a display of the predetermined time for both the local time and the recipient time.

10. The method of claim 8 further comprising:
monitoring a file location for reception of a predetermined file; and
determining that the release event is valid if the predetermined file is received from the authorized user at the file location before the predetermined time.

11. The method of claim 8 wherein:
determining that the release event is valid when a condition of the step indicates a response format that is met by the response of the authorized user; and
releasing the at least one document over the predetermined channel at the predetermined time for public availability.

12. The method of claim 8 further comprising:
selecting a workflow to process the release event from among a plurality of workflows based on the data, wherein the plurality of workflows each comprise a different step from one another for authorizing the release event before the one or more documents are sent at the predetermined time, and wherein the different step in the workflow points to an object in memory that identifies contact information of the authorized user.

13. The method of claim 8 further comprising:
preventing sending the at least one document over the predetermined channel at the predetermined time when it is determined that the release event is invalid.

14. The method of claim 13 further comprising:
causing the display device of an authorized user to re-display information of the release event in response to a determination that the release event is invalid and that the predetermined time is within a threshold amount of time.

15. A non-transitory computer readable medium embodying programmed instructions which, when executed by a processor, are operable for performing a method comprising:
receiving data for a release event over a communication medium, wherein completion of the release event results in at least one document being sent over a predetermined channel at a predetermined time for an intended audience;
processing the different step of the workflow selected for the release event to identify an authorized user;
causing a display device to display information of the release event;
determining whether the release event is valid based on a response from the authorized user; and
sending the at least one document over the predetermined channel at the predetermined time when it is determined that the release event is valid.

16. The medium of claim 15 the method comprising:
identifying a local time corresponding to the predetermined time for the workflow server;
identifying a recipient time corresponding to the predetermined time for a recipient associated with the predetermined channel, wherein the local time and the recipient time are different; and
causing the display device to display the information of the release event including a display of the predetermined time for both the local time and the recipient time.

17. The medium of claim 15 the method comprising:
monitoring a file location for reception of a predetermined file; and
determining that the release event is valid if the predetermined file is received from the authorized user at the file location before the predetermined time.

18. The medium of claim 15 the method comprising:
determining that the release event is valid when a condition of the step indicates a response format that is met by the response of the authorized user; and
releasing the at least one document over the predetermined channel at the predetermined time for public availability.

19. The medium of claim 15 the method comprising:
selecting a workflow to process the release event from among a plurality of workflows based on the data, wherein the plurality of workflows each comprise a different step from one another for authorizing the release event before the one or more documents are sent at the predetermined time, and wherein the different step in the workflow points to an object in memory that identifies contact information of the authorized user.

20. The medium of claim 15 the method comprising:
preventing sending the at least one document over the predetermined channel at the predetermined time when it is determined that the release event is invalid.
